(19) United States
(12) Patent Application Publication
(10) Pub. No.: US 2008/0086840 A1
(43) Pub. Date: Apr. 17, 2008

(54) HANGER SYSTEM FOR CONNECTING WINDOW BALANCES AND CARRIERS

(75) Inventors: Richard S. deNormand, Victor, NY (US); Wilbur James Kellum III, Hilton, NY (US); Douglas E. Zinter, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING CO., Rochester, NY (US)

(21) Appl. No.: 11/828,527

(22) Filed: Jul. 26, 2007

Related U.S. Application Data
(60) Provisional application No. 60/820,618, filed on Jul. 28, 2006.

(51) Int. Cl. E05D 13/00

(52) U.S. Cl. 16/193

(57) ABSTRACT

This hanger system for use in window balances features a hanger connected at a lower end of a window balance. The hanger has a carrier interface for connection to the window sash carrier. The carrier has a hanger interface for connection to the hanger. The interfaces are connected and disconnected by a pivoting motion of the hanger with respect to the carrier. Once connected these elements cannot be pulled apart and disconnected by tensile forces without first reversing the assembly steps. A snap connection may also be advantageously added to the hanger and carrier, allowing them to snap together in permanent or non-permanent fashion when fully or partially pivoted into alignment with each other.

### FIELD OF THE INVENTION

The invention pertains to the field of window balances. More particularly, the invention pertains to a hanger system for use in connecting a window balance to a sash carrier.

### BACKGROUND OF THE INVENTION

Numerous types of hangers and hanger systems for attaching carriers to window balances exist. The most typical and simple are metal hooks and clips that connect at one end to the window balance channel (or a rivet passing through the channel), and at the other end to the carrier for the sash.

The present hanger system relates to both single and double hung window systems. Single hung window systems have only a single sash and double hung windows have two sashes, each of which are inserted into jamb channels of the window frame to enable the vertical movement of the sashes. A locking pivot facilitates the cleaning and/or removal of each sash by allowing the sash to be tilted with respect to the window frame. Carriers are used to control the vertical movement of the sash throughout the jamb channel and facilitate the pivoting of the sash by lockingly engaging the sash to the jamb channel as the sash is pivoted. The pivot means can be a cylindrical rod or guide pin that inserts into the opening of a rotatable cam located in the carrier. As the cam rotates, it urges locking members forcibly against the walls of the jamb channel to secure the carrier in place at that specific location along the jamb.

The initial assembly of pivotable windows can be complex. Additionally, in order to replace an aged, broken or malfunctioning carrier or balance, a portion of the jamb channel often must be deformed or entirely removed and replaced to gain access to the defective part. Also, since conventional balance systems consist of an integral balance/carrier assembly, the entire assembly must be replaced even though only one element may be defective. It is desirable, therefore, to provide a carrier and balance system that will facilitate the initial assembly of the window, permit easier removal and replacement of certain defective parts of the sash balance system once the window has been installed in the wall of a building and allow the replacement of only the defective part rather than the entire carrier and balance assembly.

### SUMMARY OF THE INVENTION

The carrier and hanger combination of the present invention features a hanger adapted for connection at a lower end of the channel of a window balance. The hanger has a channel interface for connection to the channel and a carrier interface for connection to the carrier. The carrier likewise has a hanger interface for connection to the carrier interface of the hanger. These interfaces are connected and disconnected by a pivoting movement of the hanger with respect to the carrier after the carrier interface is inserted into the hanger interface.

After assembly, the carrier and hanger cannot be pulled apart or otherwise disconnected merely by a tensile force without first reversing the pivoting movement by which they were connected and removing the hanger interface from the carrier interface. A snap feature may also be added to the hanger and carrier interfaces if desired, allowing them to snap together in permanent or non-permanent fashion when fully or partially pivoted with respect to each other after alignment in the sash channel.

### BRIEF DESCRIPTION OF THE DRAWINGS

FIG. 1 shows a perspective view of the novel hanger/balance assembled with the novel sash carrier, installed within a typical window jamb channel, which is illustrated as semi-transparent so as to allow better viewing of the hanger system of the invention.

FIG. 2A shows a perspective view of the hanger of the instant invention.

FIG. 2B shows a perspective view of the carrier of the instant invention.

FIG. 2C shows a perspective view of the hanger and carrier being aligned prior to being assembled together.

FIG. 3A shows a first cut-away view of the hanger and carrier are in the initial process of being connected together.

FIG. 3B shows a second cut-away view of the hanger and carrier are further along in the process of being connected together.

FIG. 3C shows a third cut-away view of the invention after the hanger and carrier are completely connected together.

FIG. 3D shows a perspective view of the invention with the hanger and carrier connected together.

### DETAILED DESCRIPTION OF THE INVENTION

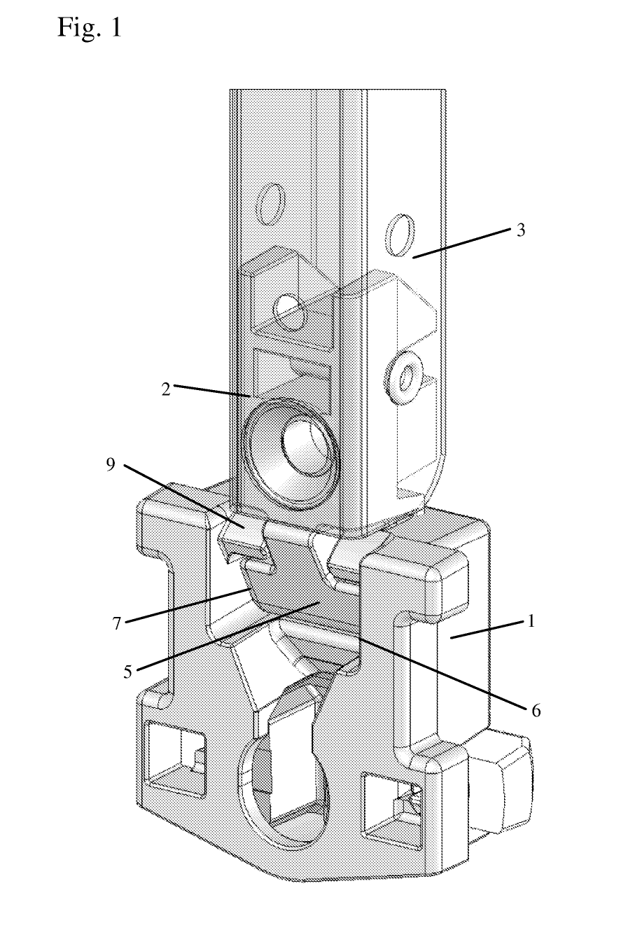

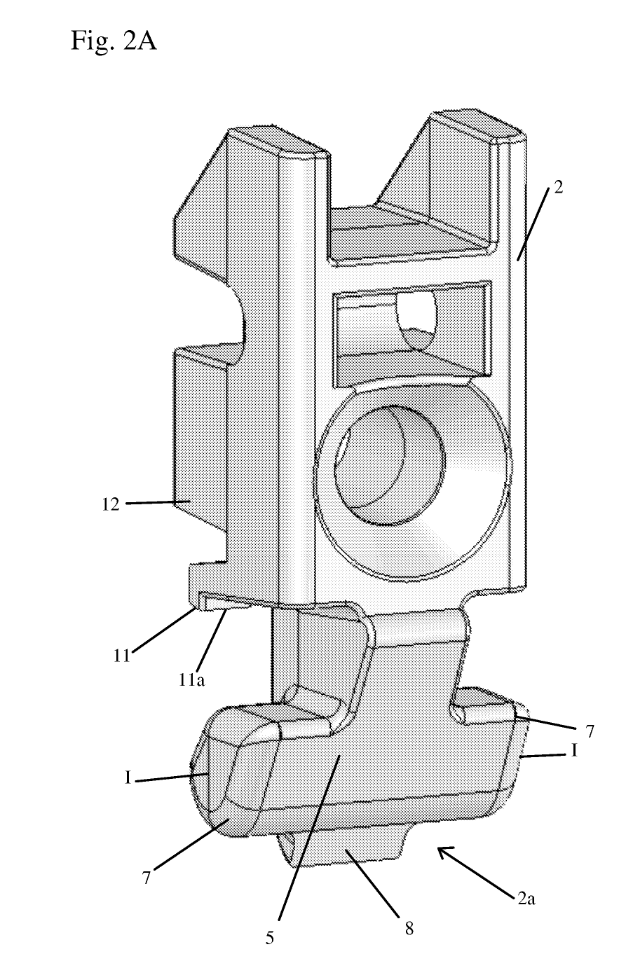

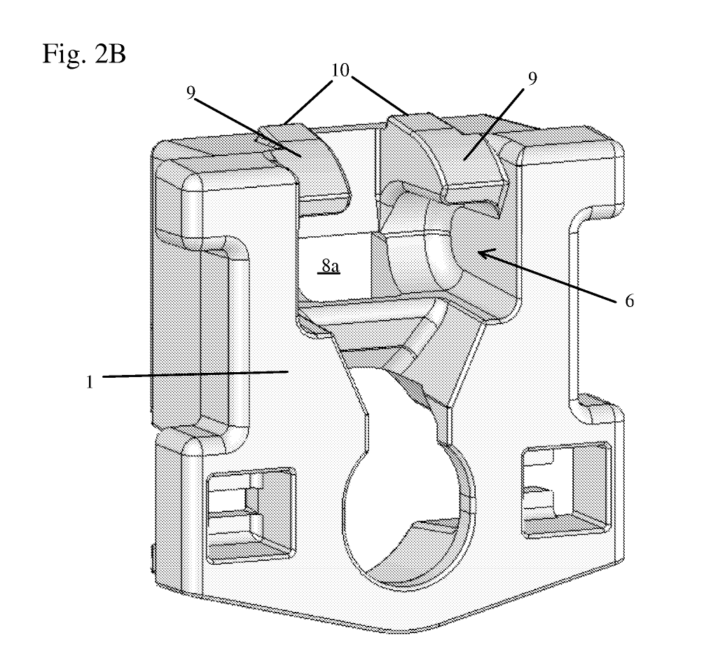

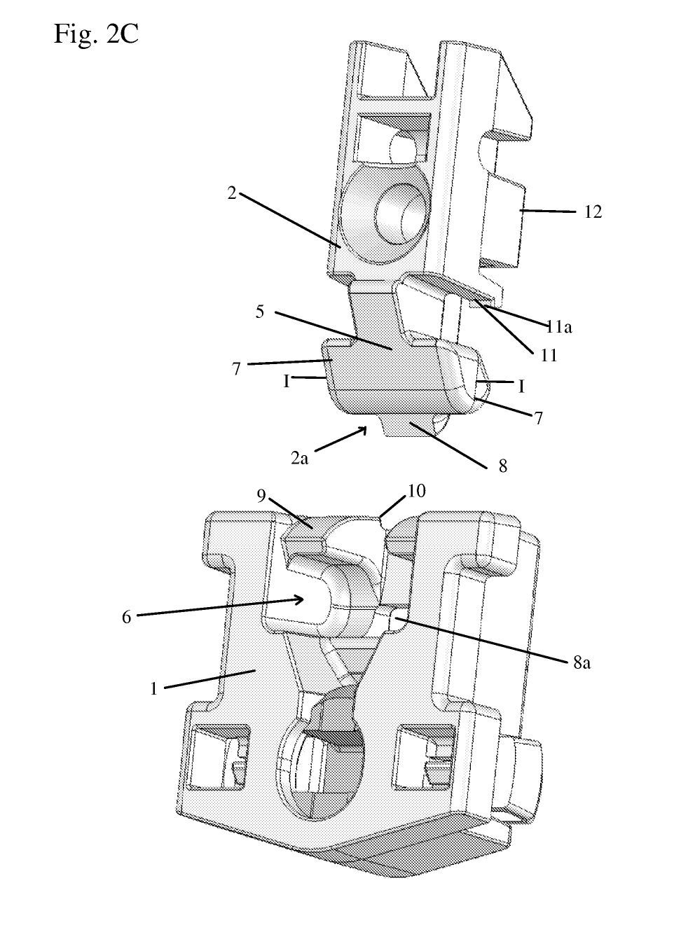

FIG. 1 shows the unique features of the present window hanger system. A carrier 1 is shown connected to a hanger 2. The hanger 2 is conventionally connected to the lower end of a balance 3. The hanger and carrier are connected to each other by inserting a hanger interface 5 (best shown in FIG. 2B), located at the first end 2a of the hanger 2, into a carrier interface 6 located on carrier 1.

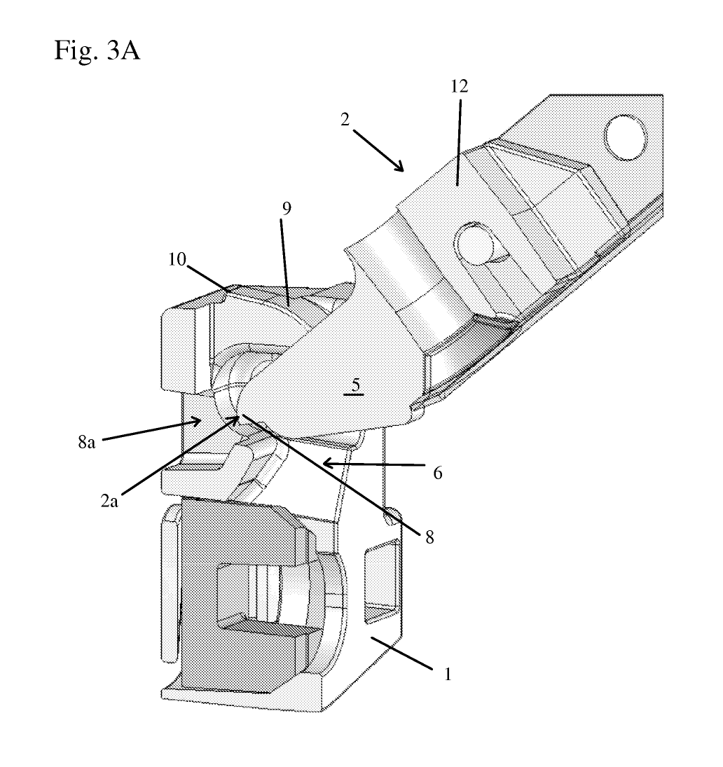

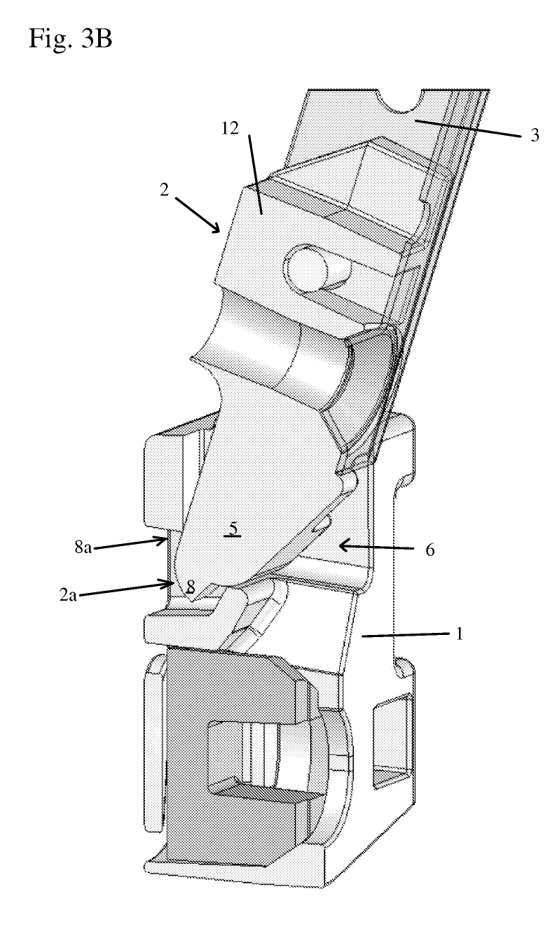

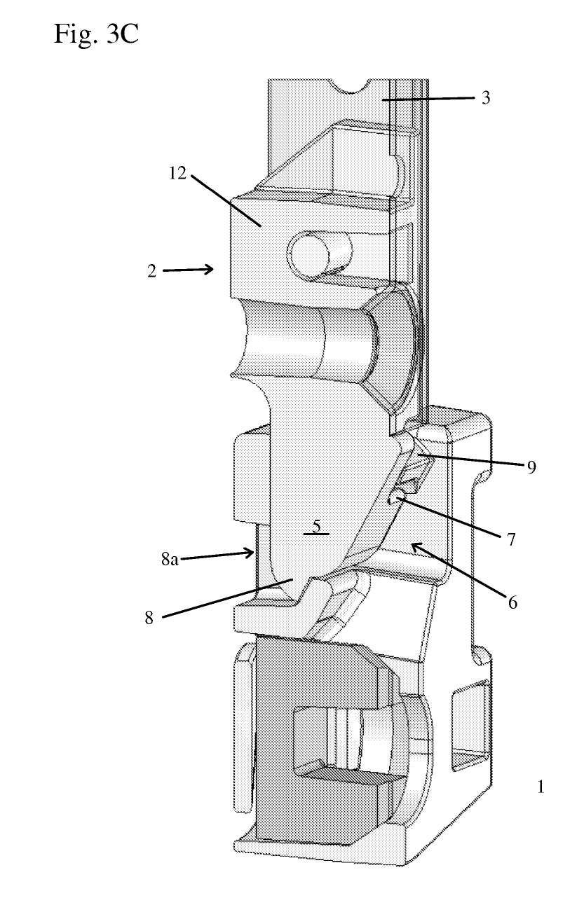

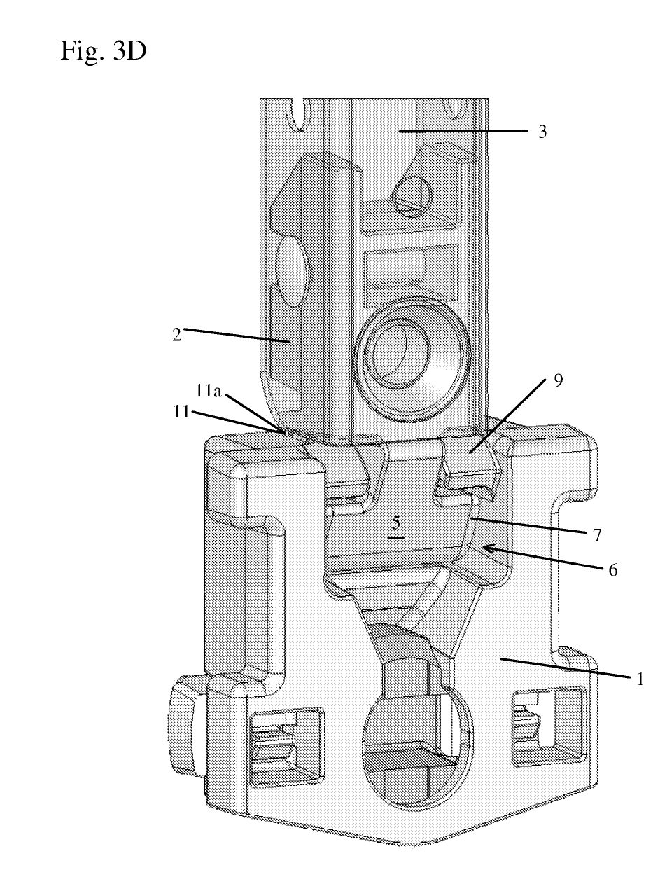

Elements of the hanger interface 5 and of carrier interface 6 create an interference fit between the hanger interface 5 and the carrier interface 6 when connected together, as will be described below. Referring to FIG. 2B, the carrier interface 6 consists of a recess for receiving the substantially cruciform shaped hanger interface 5. Hanger interface 5 consists of opposing shoulder like features 7 and an upset tab 8 located at the first end 2a of the hanger 2. An artificial axis I traverses substantially through and between the shoulders 7. The hanger interface 5 and the carrier interface 6 are sized to fit securely together such that once fitted together the hanger and the carrier form a solid structural element to enable the vertical movement of the carrier through the jamb channel, in turn permitting the sash to traverse vertically upward or downward, as desired. The securely joined hanger and carrier form the assembly shown in FIGS. 1 and 3D. Hanger 2 cannot be pulled apart or otherwise disconnected from carrier 1 by movement or forces in a direction parallel to the longitudinal axis of balance 3 (or the longitudinal axis of the jamb channel) after connection.

The assembly of the carrier 1 with the hanger 2 requires that the carrier 1 first be installed into the jamb channel (not shown) by inserting the carrier 1 into either open end of the jamb channel prior to assembly of the jamb channel into a window frame. Turning to FIGS. 3A and 3B, which are sequential, the first end 2a of hanger 2 is inserted into the carrier interface 6 of the carrier 1 at less than a 90 degree angle with respect to the carrier 1 lying within the jamb channel. As the first end 2a of the hanger 2 is inserted into the carrier interface 6, upset tab 8 is inserted into a substantially centrally located locking port 8a, guiding the hanger 2 (with its attached balance 3) into a position for proper alignment with carrier 1.

By pivoting the hanger 2 along axis I, each of the shoulders 7 of hanger 2 becomes engaged beneath a corresponding arctuate member 9, which are integrally formed elements of carrier 1. Guiding ledges 11, integrally formed with the body 12 of hanger 2, are located opposite shoulders 7 and traverse along the outer surfaces of arctuate members 9 as the assembly process continues. Once the hanger 2 and carrier 1 are non-permanently connected together, they can be separated only by reversing the aforesaid process. They cannot be separated by the tensile forces exerted on and by the window balance assembly during movement of the window sash up and down the jamb channel. This is because the forces that operate on the combined hanger 2 and carrier 1 within the jamb channel function only in a direction essentially parallel to the longitudinal axis of the jamb channel or the balance 3. The locking engagement of the hanger interface 5 into the carrier interface 6 prevents disengagement of these elements. Once the carrier 1 and the hanger 2 are lockingly engaged by connection of the hanger interface 5 into the carrier interface 6, they can only be separated by reversing the assembly process which requires that the hanger 2 be pivoted along axis I until the longitudinal axis of the balance approaches approximately a 90 degree angle with respect to carrier 1, and then disengaging the hanger interface 5 from the carrier interface 6.

A snap connection may also be advantageously added to the hanger 2 and carrier 1, allowing them to snap together in either permanent or non-permanent fashion when fully or partially pivoted into locking engagement with each other. As shown in FIG. 2B, a first snap member 10 is located along the curve of each of the arctuate members 9 on carrier 1. A second snap member 11a (see FIG. 2C) having more flexibility than first snap member 10 is integrally connected to the body 12 of hanger 2 and is located on each guiding ledge 11. During the assembly process, as the hanger 2 is pivoted along axis I, the guiding ledge 11 slides along the surface of its respective arctuate member 9 until the resistance of the flexibility of the corresponding second snap member 11a is overcome and is allowed to snap over the first snap member 10.

The snap feature is considered an optional element since when the hanger and carrier are fully engaged within the jamb channel and under tension from the balance, the tension of the balance provides sufficient force to maintain secure engagement of the carrier 1 and the hanger 2. The snap connection may be used to provide a more secure interlocking engagement. Various alternate embodiments include moving the snap connection lower down the curve of each of arctuate members 9, to allow looser engagement between the carrier 1 and the hanger 2, should that be desired.

Numerous alternate embodiments of the male/female locking interface feature of the device described hereinabove are possible within the constraints of this description. Accordingly, it is to be understood that the embodiments of the invention herein described are merely illustrative of the application of the novel features described above.

What is claimed is:

1. A hanger system for window balances comprising:
a) a hanger connected to a lower end of a window balance, the hanger having a carrier interface adaptable for connection to a mating carrier; and
b) the carrier having a hanger interface adaptable for connection to the hanger.

2. The hanger system of claim 1 wherein the carrier and hanger are non-permanently connected to each other by insertion of the hanger interface into the carrier interface and after pivoting the hanger with respect to the carrier.

3. The hanger system of claim 2 wherein the hanger interface is substantially cruciform shaped and includes an upset tab at a first end of the hanger, two shoulders each located on opposing sides of the upset tab and an artificial axis traversing through the shoulders.

4. The hanger system of claim 3 wherein the hanger further comprises a guiding ledge opposite each shoulder and integrally formed with the hanger.

5. The hanger system of claim 2 wherein the carrier interface includes a recess substantially corresponding to the shape and size of the hanger interface, the carrier interface having a substantially centrally positioned locking port and two arctuate members integrally formed with the carrier.

6. A method for assembling a hanger system for window balances, wherein the hanger system includes a hanger connected to a balance, the hanger having a substantially cruciform shaped carrier interface including opposing shoulders defining an artificial axis, the carrier having a hanger interface corresponding to the shape and size of the carrier interface of the hanger, comprising the steps of:
a) installing the carrier into a window frame jamb channel, the jamb channel having a longitudinal axis;
b) positioning the hanger at less than a 90 degree angle with respect to the longitudinal axis of the jamb channel and orienting the carrier interface for insertion into the hanger interface; and
c) inserting the carrier interface into the hanger interface and pivoting the hanger about the axis of the shoulders until the balance lays against the jamb channel.

7. The method of claim 6 further comprising corresponding snap elements on the hanger and the carrier to interlock the carrier and the hanger.
